(19) United States
(12) Patent Application Publication
(10) Pub. No.: US 2003/0015823 A1
(43) Pub. Date: Jan. 23, 2003

(54) Method for forming a thick section, thermoset, solid casting

(75) Inventor: Dirk Maarten de Winter, Vista, CA (US)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: Hydranautics

(21) Appl. No.: 09/908,227

(22) Filed: Jul. 18, 2001

(51) Int. Cl. B29C 39/10

(52) U.S. Cl. 264/279

(57) ABSTRACT

Thick section, thermoset, solid castings are formed by a two component reactive resin system, including a resin component A and a hardener component B, wherein a minor portion of the total stoichiometric charge of the resin A is mixed with substantially the entire charge of hardener B to form a modified hardener component C. After allowing the modified hardener C to cool, it is mixed with the remainder of the charge of resin A to form a viscous fluid casting mixture which can be cast into the desired thick section shape. The casting to final shape proceeds at a slower rate with reduced exotherm and more controlled shrinkage, thereby avoiding cracks and other defects in the thick section shape. After cooling and allowing the cast thick section shape to cure and harden to a final solid casting, the casting has the same hardness as a casting produced by a conventional mixing of the total charge of resin A with hardener B.

### BACKGROUND OF THE INVENTION

The present invention is directed to a method for forming thick section, thermoset resin castings. More particularly, the invention involves techniques for casting two component, reactive resin systems having at least a resin component and a hardener or curing component

The reaction of two or more component thermosetting resin systems usually involves the production of a large amount of heat (exotherm). When these thermoset resins, such as epoxy or urethane resin adhesives, are used to produce thick section moldings, castings or pottings, the large amount of heat generated by the exothermic reaction cannot be easily removed, resulting in various processing problems and/or product defects. For example, since the reaction rate doubles with every 10° C. increase in temperature, runaway reactions and even explosions can result. Moreover, as the large mass of the thick section cools down, the setting mass of resin shrinks, creating stresses in the mass, and cracks appear since the outside dimensions of the casting do not change due to adhesion of the resin to the mold.

The above and other problems have manifested themselves in the production of porous membrane filtration modules. Thus, in the preparation of large (e.g., four, eight or sixteen inch diameter) filtration modules containing spiral wound or hollow fiber porous membrane elements, the ends of the cylindrical modules are typically sealed off by potting the ends of the porous membranes in a large epoxy resin mass, which fills each end diameter of the module to a depth of two or three inches, for example. If the large amount of heat produced by the exothermic reaction of the epoxy system cannot be removed or dissipated, the large potting mass can reach temperatures of close to 190° C. as the reaction reaches completion at a rapid rate. As the mass cools down and shrinks, cracks appear, which can result in leaks or even explosion of the filtration module when placed under high pressure. When totally cured, epoxy is about 7% more dense than immediately after mixing the components.

In attempts to solve the above problems, manufacturers have resorted to a variety of different techniques to cool the epoxy potting charge and to allow time for the potting mass adjust to the final dimensions while relieving stresses. One technique uses a multi-layer, staged potting method in which two or more layers are poured in sequential stages timed to allow for curing of the respective previous stage and dissipation of the resulting heat. Another method involves insertion of stainless steel cooling coils in the potted section. Urethane resin potting systems can also be used, but without adequate heat removal, the large potting mass of urethane can reach temperatures of up to 140° C. as the reaction reaches completion. Low curing-temperature resins have the disadvantage of taking a very long time to cure, so that a thick potting of 2-3 inches or more, which cannot be cast in one casting without using a low curing-temperature resin, would be prohibitively time-consuming. All of these techniques require a heat sink or cooled pot to cool the module walls and the end of the module where the potting is being formed.

These prior art techniques are cumbersome and/or expensive and have not been entirely satisfactory in reducing or controlling the high exotherm of epoxy and other thermosetting resin reaction systems used for thick section moldings, castings or pottings. Accordingly, the above-mentioned problems of the prior art have not been totally resolved, and more effective potting techniques are desired.

### BRIEF SUMMARY OF THE INVENTION

The above and other problems of the prior art are alleviated by the method of the present invention in which thick section, thermoset, solid castings are formed from two or more component, reactive, resin systems comprising at least a resin component A and a hardener component B, wherein the method includes the following steps:

providing approximately stoichiometrically equivalent charges of resin component A and hardener B;

mixing a minor portion of the total charge of resin component A with substantially the entire charge of hardener component B to form a modified hardener component C;

allowing the modified hardener component C to cool;

mixing the remainder of the charge of resin component A with the modified hardener component C to form a fluid casting mixture;

casting the fluid casting mixture into a desired thick section shape; and

allowing the cast thick section shape to cool and set to a solid casting.

The two component reactive resin system is preferably an epoxy resin-based system. The minor portion of the charge of resin component A added to the hardener B may be about 5 to about 40 mol percent of the total charge, and preferably about 10 to about 25 mol percent of the total charge. In a preferred embodiment the invention is used for potting semipermeable, hollow fiber, membrane elements in the ends of filtration modules.

### DETAILED DESCRIPTION OF THE INVENTION

The method of the present invention may be used with virtually any thermosetting resin system including two or more components in which at least one component is a resin component (often referred to herein as “component A”) and at least one component is a hardener component (often referred to herein as “hardener B”). A third or other components may also be used, for example, where cross-linking or other reactions are desired. However, such additional components are generally not preferred because they increase or complicate the reaction kinetics.

The invention will be described with particular reference to epoxy resin systems, namely compounds containing epoxide reactive groups which react with other compounds having reactive hydrogen atoms. However, it will be understood by those skilled in the art that the method of the present invention could be used with other two or more component, reactive, thermosetting resin systems, including, for example, urethane resin systems.

Examples of epoxide reactive group-containing resins for use in the present invention are the well-known bisphenol A diglycidyl ether resins prepared by condensing epichloride with polyhydric alcohols or phenols, such as the condensation of epichlorohydrin with bisphenol-A (bis (4-hydroxyphenyl) dimethylmethane), which is a diepoxide; and epoxy propyl esters of trialkyl acetic acids.

Examples of hardener components B are diamines having the general formula:

H₂N—R—NH₂ (B)

wherein R may be an alkyl or aryl group. While the R group could contain three or more reactive amine groups on each molecule, this will cause cross-linking, which is generally undesirable. Thus, cross-linking may cause the modified hardener component C (discussed below) to become a solid or a gel and therefore not useful for further compounding.

Preferred amines for use in the present invention are the polyether amines, particularly polyoxypropylenediamines. Other suitable amines include, for example, 2-methylpentamethylene diamine, and other aliphatic and polymeric amines.

Commercially available epoxy resin systems suitable for use in the present invention include, for example, Permabond™ E3030 from Permabond Division of National Starch & Chemical, Ltd. of Eastleigh, Hampton, England; EPMAR™ SS1929 from Epmar Corporation of Santa Fe Springs, Calif.; FE-7258 from H. B. Fuller Company of Vadnais Heights, Minn.; and Jeffco™ 4105 from Jeffco Products Co. Inc. of San Diego, Calif.

The method of the present invention essentially entails the reduction of exotherm by forming a portion of the bonds (reacting a portion of the reactive groups) prior to final mixing of the total charge of each of the components, and removing the heat produced by this preliminary reaction. This preliminary reaction has more than a proportional effect on the reduction of the reaction rate of the remaining and modified components.

Thus, a new or modified hardener component (often referred to herein as “modified hardener component C”) is prepared by mixing a minor portion (less than half) of the resin component A with substantially the entire quantity of the original hardener component B. Depending upon the particular resin system chosen, the portion of resin component A mixed with the total charge of hardener component B may be about 5 to about 40 mol percent, i.e., an amount which will react stoichiometrically with about 5 to about 40% of the hardener reactive groups. Preferably, the portion of the resin component reacted in this first stage is about 10 to 25 mol percent of the total charge, and more preferably about 16 to 20 mol percent of the total charge.

After thorough mixing of the minor portion of resin component A and the charge of hardener component B, the reaction is allowed to take its course, or may be actively cooled, in either case preferably to ambient temperature. Typically, with the preferred epoxy resin systems mentioned above, the temperature increases in two hours to about 90 to 125° C., and then cools overnight. The thus-modified hardener component C is a solution containing mostly unreacted hardener component A plus oligomers of the resin component A and hardener component B. In the preferred systems discussed above, where the hardener B is a diamine, the oligomers are formed between R-diamine ends, wherein an amine group is free at each end for subsequent reaction.

This new or modified hardener component C is preferably one which remains as a stable liquid solution for extended periods of time for subsequent reaction with the remainder of the charge of resin component A. It has been found with preferred resin systems according to the invention that the modified hardener C remains at constant viscosity for over six months. This allows pre-mixing of the minor portion of resin A with the hardener B and storing until ready for use. When the modified hardener C is mixed with the balance of the resin component A, the reaction progresses at a slower rate, since a significant number of the reaction sites have been consumed in the preliminary stage. This allows for heat dissipation from a thicker resin section without a runaway reaction. That is, the technique allows for curing of relatively larger volumes of resin with more manageable removal of heat of formation.

Although the method of the present invention can be used for layers of thermoset resin of virtually any thickness, it has particular advantage for thick sections, for example, shapes having a thickness of about one inch or greater. Thus, films, coatings and thin section shapes can more readily dissipate the heat of formation, so that the technique of the present invention is not usually necessary. However, when casting thick sections, such as the potting of porous membrane filtration modules which may have a plug thickness of up to about three inches, the use of the present invention is particularly advantageous.

An unexpected advantage of the present invention is the higher viscosity of the modified hardener component C as compared to the original hardener component B. Thus, amine hardeners are usually very runny, so that there is often a problem of gear pump feeding of the hardener as compared to the gear pump feeding of the more viscous resin component A. However, with the method of the present invention, both the remainder of the resin component A and the modified hardener component C are relatively viscous fluids, so that feeding of these two components to the final mixture is more uniform and less problematic. In fact, the amount of resin A added to hardener B can be selected so as to balance the viscosity of the modified hardener C to that of the remaining resin A.

A further unexpected advantage of the present invention, in the case of potting hollow fiber membrane filtration elements, is the higher viscosity of the final fluid casting mixture. Thus, high temperature created by reaction exotherm lowers viscosity and allows conventional resin mixtures to travel up the capillary fibers (wicking) and block the membrane. With the present method, the higher viscosity avoids excessive wicking of the resin/hardener mixture up into the capillary fibers, so that masking or occluding of the membrane above the potting mass is avoided to a greater degree. The avoidance of wicking also leaves more resin at the potting area where it is needed.

On the other hand, due to the higher viscosity of the final fluid casting mixture, it is preferred that cooling of this mixture not be started until the mixture has been poured, pumped or otherwise cast into its desired thick section shape. Thus, when the remainder of the charge of resin component A is mixed with the modified hardener component C, the curing reaction begins immediately with concomitant release of the reaction exotherm. This exotherm serves to decrease the viscosity of the mixture or at least maintain the viscosity at a low enough level to allow casting and flowing of the mixture into its final desired shape. If cooling of the mixture is begun immediately or during mixing, the viscosity of the final mixture may increase to such an extent that the mixture will be difficult to pour, pump or otherwise cast, depending upon the particular resin and hardener materials used and the viscosity of the modified hardener component C. Of course, one skilled in the art can readily determine by routine experimentation the optimum time to begin cooling of the final mixture, depending upon a variety of factors including the particular resin/hardener system used, the viscosity of the modified hardener C, the complexity of the shape to be cast, etc.

When casting thick section shapes with the method of the present invention, it will still usually be necessary to cool the cast mixture to dissipate the high exotherm, depending upon the particular resin system used and the thickness of the casting. Various cooling means for this purpose are well-known to those skilled in the art, including such devices as heat sinks and cold water cooling coils surrounding or contacting the mold or the casting mixture itself in the final cast shape. Usually, the cooling is continued for a sufficient time to prevent overheating and to cause the reaction to proceed at a sufficiently slow rate to allow the hardening mass to adjust to the final dimensions of the cast shape, while relieving stresses in the setting mass to avoid rapid shrinkage and resulting cracks.

As is readily understood by those skilled in the art, once the high exotherm is dissipated and the rate of the curing/hardening reaction is sufficiently slowed, the cooling means can be removed and the final curing allowed to proceed at ambient temperature. It may be desired in some cases to heat the final mass at some point to accelerate slower parts of the cure cycle. Depending upon the particular resin system used, this final curing may continue over several days, or even weeks. It has been found that the density of the casting after complete curing is the same according to the present invention as if the entire charges are mixed together in one step.

While the invention has been described with particular reference to the potting of porous membrane elements in filtration modules and the particular advantages achieved with such potting applications, the method of the invention may be advantageously used in other applications, such as large volume potting of electrical components and the general molding of thick section, thermoset shapes.

The invention will now be illustrated with reference to the following specific, non-limiting examples.

### EXAMPLE 1

Permabond™ E3030, supplied by Permabond Division of National Starch & Chemical Ltd., was selected as an epoxy resin system. The resin in this system comprises epoxy propyl ester of trialkyl acetic acids and the hardener comprises polyoxypropylenediamine. A premix was prepared from 30.6 g of hardener component B and 12.7 g of resin component A (12% of the total 106.55 g of part A needed for total reaction with the hardener). Upon mixing of B with 12% of A, the reaction mixture increased in temperature about 15° C. After twenty-four hours the premix had an excellent viscosity approximately the same as resin component A alone.

### EXAMPLE 2

Another premix was formed from the resin and hardener components of Permabond™ E3030, using 24.25 g of B and 28.06 g of A (25% of the total charge of A needed for complete reaction). This premix turned solid within about three days and was thereafter unusable for further mixture with the remainder of A.

### EXAMPLE 3

Another premix of Permabond™ E3030 components was prepared using 375.48 g of B and 207.12 g of A (16% of the total charge of A needed for complete reaction). Three days later the remaining 84% of resin component A (1087.4 g) was added to the premix and allowed to harden with cooling water supplied for about six hours and then with warm water supplied for about eight hours. The cast solid had a hardness of 76 on the Shore D durometer scale after two days, 82 after three days and 85.0 after eight days.

For comparison a standard casting was prepared in which the entire charge of resin A (79.11 g) was mixed with the entire charge of hardener B (22.04 g) and allowed to solidify. Hardness measurements yielded 77 after two days, 82 after three days and 85.0 after eight days.

### EXAMPLE 4

A larger premix was prepared using the Permabond™ E3030 resin system by mixing 4.93 kg of hardener B with 2.72 kg of resin A (16% of the total 17.0 kg charge of resin A required for complete reaction), and the premix was allowed to cool to ambient temperature. A final casting mixture was then prepared from 0.59 kg of the premix (modified hardener C) and 1.1 kg of resin A, and the resulting mixture was used to pot the hollow fibers at the ends of a hollow fiber filtration module. The viscous potting mixture was fed into the area at the end of an eight inch diameter hollow fiber element filtration module without precooling of the mixture. The end of the module was positioned in an aluminum “pot” provided with cold water cooling coils as a heat sink. The bottom of the pot was provided with a teflon coating and smeared with silicon grease to prevent sticking of the epoxy resin to the pot. The coils of the pot were provided with cooling water for six hours and then with warm water for eight hours to harden the casting. At this point, the cure of the resin casting was still incomplete, and rather tacky or gummy. However, the three inch thick casting was sufficiently hard to be removed from the pot and allowed to stand and cure for about one week. The solidified potting from one end of the module was cut off for conducting hardness measurements. The hardness of the solidified potting was 82 after two days, 84.5 after three days and 85.0 after eight days.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for forming a thick section, thermoset, solid casting from an at least two component reactive resin system comprising a resin component A and a hardener component B, comprising the steps of:
providing a charge of resin component A and an approximately stoichiometrically equivalent charge of hardener component B;
mixing a minor portion of the total charge of resin component A with substantially the entire charge of hardener component B to form a modified hardener component C;
allowing the modified hardener component C to cool;
mixing the remainder of the charge of resin component A with the modified hardener component C to form a viscous fluid casting mixture;
casting the fluid casting mixture into a desired thick section shape; and
cooling the cast mixture and allowing the cast thick section shape to cure and harden to a solid casting.

2. The method according to claim 1, wherein the resin component A comprises epoxide reactive groups and the hardener component B comprises amine groups.

3. The method according to claim 2, wherein the resin component A comprises an epoxy ester and the hardener component B comprises a diamine compound.

4. The method according to claim 3, wherein the resin component A comprises an epoxy propyl ester of trialkyl acetic acids and the hardener component B comprises a polyoxypropylenediamine.

5. The method according to claim 1, wherein the minor portion of the charge of resin component A is about 5 to about 40 mol percent of the total charge.

6. The method according to claim 1, wherein the minor portion of the charge of resin component A is about 10 to about 25 mol percent of the total charge.

7. The method according to claim 1, wherein the thick section shape is at least about one inch thick.

8. The method according to claim 1, wherein the thick section shape is a potting for porous membrane filtration modules.

9. The method according to claim 8, wherein the porous membrane comprises hollow fibers with semipermeable walls.

10. The method according to claim 1, wherein the thick section shape is a potting for electrical components.

11. The method according to claim 1, wherein the modified hardener component C is cooled to about ambient temperature before mixing with the remainder of the charge of resin component A.

12. The method according to claim 1, wherein neither resin component A nor resin component B has more than two reactive groups per molecule.
